(19) United States
(12) Patent Application Publication
(10) Pub. No.: US 2002/0099574 A1
(43) Pub. Date: Jul. 25, 2002

(54) Method of electronically reserving a space for parking a vehicle

(76) Inventors: John J. Cahill, Pleasanton, CA (US); Charles Colby, Palo Alto, CA (US); Marty Parker, Paso Robles, CA (US); Rudy Hinojo, Paso Robles, CA (US); Emmet H. Soper, Palo Alto, CA (US)

Correspondence Address: Paul Hentzel, 441 Nevada Ave, Palo Alto, CA, 94301, US

(21) Appl. No.: 09/766,171

(22) Filed: Jan. 22, 2001

(51) Int. Cl. G06F 17/60

(52) U.S. Cl. 705/5

(57) ABSTRACT

Parking area 10 has several rows of parking spaces 12 which are managed by parking area server 14. The server is linked to parties requesting reservations through multi communication channels forming network 16. Availability status database 14S is maintained by the server for storing the availability of each space. Party historical database 14H is also maintained by the server for storing the parking history of certain parkers. The availability data and historical data in these databases is available to the server during the reservation process.

### TECHNICAL FIELD

This invention relates to reserving a parking space, and more particularly to such reservation made remotely through an electronic communication network.

### BACKGROUND

Heretofore urban parking lots employed mechanical entrance counters to count the cars entering the lot, and exit counters to count the cars leaving the lot. The difference between the entrance count and the exit count at any given time was an indirect indication of the number of cars parked in the lot. The lot attendant could easily determine the number of vacant parking spaces available (capacity of the lot minus number of parked cars). The availability of each individual parking space was not provided by this simple prior count technique. The attendant did not know where the vacant spaces were located in the parking lot, or the particular attributes (width, distance to elevator, etc.) of these vacant spaces. An incoming driver was required to tour the lot until he found a vacant space, and accept whatever attributes the space offered. When the lot was full to capacity, approaching the drivers were turned away at the entrance to find another lot, which also might be full. Further, as the lot approached capacity, entrance/exit miscounts could lead to turning away vehicles when space was actually available and to admitting vehicles when the lot was full.

### SUMMARY

It is therefore an object of this invention to provide a method of electronically reserving a parking space. A parking area server receives reservation inquiries or requests from requesting parties for reserving a space for a specified time. The request may come to the server from the keypad on a mobile cell phone, or from the keyboard of an on-line computer, or an automobile computer with a web interface. The server is a computer in data communication with an availability database storing time-base availability for each space. The database identifies each space by a unique ID number and contains the availability (either available or not available) for that space at a particular time. The server determines if a space is available and reserves that space by ID number for the requesting party. The reservation may be done without a parking attendant or a reservation person or any other human assistance.

It is another object of this invention to provide such a reservation method which provides attributes of available spaces for better informing the requesting parties of their reservations options. The server is in data communication with an attribute database (in addition to the above availability database) which stores notable features of each identified space. After receiving a reservation request, the server provides a menu of attributes for the requesting party. SUV drivers may want a larger space for this larger vehicle, or an end space with adjacent room for unloading cargo, or a space near the elevator with a short cargo hauling distance. The requesting party may specify desired attributes from the menu, or specify standard default attributes. Certain attributes may be in high demand or carry a higher overhead cost, and therefore have a higher charge rate.

It is a further object of this invention to provide such a reservation method which permits the requesting party to reserve a parking space from a remote location in advance of an event. The requesting party may make the reservation from his office or home a few days or even months ahead of a critical meeting or popular opera. In a single transaction, the requesting party may make a sequence of reservations, such as standing reservation at a parking lot near the stadium for the entire season of home games. A parking space may be reserved at the same time as dinner reservations, or even be included in the dinner reservation as a service provided by fine restaurants.

It is a further object of this invention to provide such a reservation method which permits the requesting party to reserve a parking space on very short notice from his vehicle while driving to the parking area. The requesting party may inquire about available parking spaces “on-the-fly” over the communication network.

It is a further object of this invention to provide such a reservation method which can accept or reject a request in real time almost instantaneously during the request inquiry. Each parking space is monitored to detect whether the availability status of the space is “empty” or “occupied”. A computerized parking monitor installed proximate each space detects the presence and absence of vehicles. Every change in occupied status is reported to the availability database. If a parking lot is full, the requesting party can immediately contact another lot. The party can find out which lot has a suitable vacancy without actually driving to the lot.

It is a further object of this invention to provide such a reservation method in which the server may submit a close substitute alternate parking space based on the requested attributes when the requested space is not available. The server determines a second choice which best approximates the requested attributes from among all of the available spaces in the availability database. When the lot is approaching capacity, and the full spectrum of attributes is no longer available; the requesting party may have to accept an alternative set of attributes such as a larger space at a higher charge rate.

It is a further object of this invention to provide such a reservation method in which the server may submit a historical alternate parking space based on prior requests when the requested space is not available. The server maintains a party historical database of prior requests from frequent parkers. The historical database is updated each time the party reserves a space. If a request is for a third level space near the elevator is unavailable, the server consults the party historical database. In the past the parties second choice has been a corresponding space on the fourth level. From this historical basis, the server submits the fourth level space as an historical alternative.

Briefly, these and other objects of the present invention are accomplished by providing a method of reserving parking spaces within a parking area for vehicles through an electronic communication network in response to reservation requests from requesting parties. A parking area server is provided which is accessible for two-way communication with the requesting parties through the electronic communication network. Parking space data is stored in a space attribute database, identifying each parking space in the parking area by a unique space ID, and defining one or more parking space attributes for each parking space. The attribute database is in data communication with the server for providing parking space data to the server. The parking area is monitored through parking space monitors positioned in the parking area proximate the parking spaces. The monitors detect the presence or absence of vehicles in the parking spaces defining a current empty/occupied status for each parking space. The monitors are accessible for server communication for providing the empty/occupied status to the server. Time-based parking space availability data is maintained in an availability status database in response to reservations from the server and to empty/occupied status from the monitors. The availability data defines an availability attribute schedule for each parking space in the parking area. The status database is in data communication with the server for providing availability data to the server. A reservation request communication is received from a requesting party to the server via the electronic communication network, requesting a reservation for a parking space in the parking area specifying one or more requested attributes. The availability of parking spaces having the requested attributes is determined from the availability data in the availability status database and from the parking space data in the space attribute database. The reservation request from the requesting party is rejected if no parking space having the requested attributes is available. The reservation request is accepted if a parking space having the requested attributes is available. The parking space having the requested attributes is reserved for the requesting party using the unique space ID.

### BRIEF DESCRIPTION OF THE DRAWINGS

Further objects and advantages of the present reservation method and the operation of the server and monitors and databases will become apparent from the following detailed description and drawing (not drawn to scale) and flow charts in which:

FIG. 1 is a diagram showing parking area 10 with server 14 in communication with requesting parties through communication network 16;

FIG. 2 is a flow chart showing the basic steps in the general method of reserving a parking space; and

FIG. 3 is a portion of a flow chart showing additional features of the reservation method.

The first digit of each reference numeral in the above figures indicates the figure in which an element or feature is most prominently shown. The second digit indicates related elements or features, and a final letter (when used) indicates a sub-portion of an element or feature.

### REFERENCE NUMERALS IN DRAWINGS

The table below lists the reference numerals employed in the figures, and identifies the element designated by each numeral.

10 Parking Area 10

12 Parking Spaces 12

12C Compact Parking Spaces 12C

12E Elevator Parking Space 12E

12F End space 12F

12L Large Parking Space 12L

12S Standard Parking Spaces 12S

12Z Zone Parking Space 12Z

14 Parking Area Server 14

14A Space Attribute Database 14A

14H Party Historical Database 14H

14S Availability Status Database 14S

16 Communication Network 16

16C Office Computer 16C

16M Mobile Laptop 16M

16N Internet 16N

16P Cell Phone 16P

16T Cell Tower 16T

16W Telephone Wires 16W

18 Parking Monitors 18

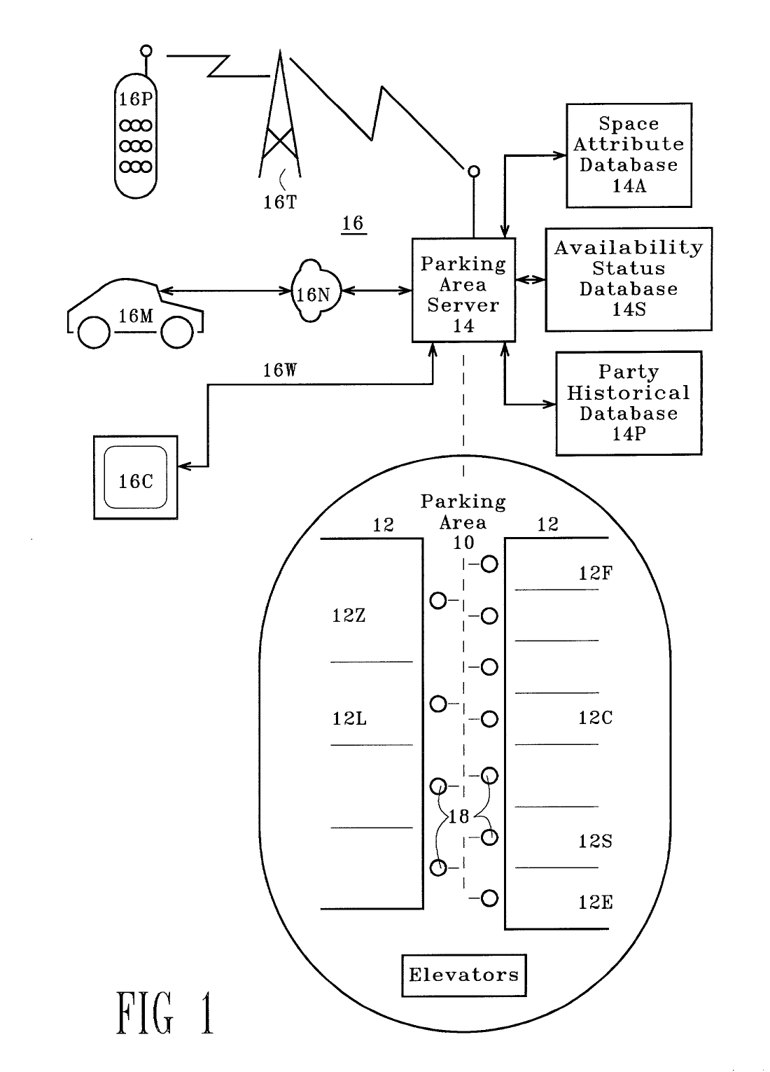

### GENERAL APPARATUS (FIG. 1)

Parking area 10 has several rows of parking spaces 12 which are managed by parking area server 14. The server is linked to parties requesting reservations through multi communication channels forming network 16. The communication network maybe any suitable electric communication mode such as a wireless cell phone system, telephone land lines, the internet, and cable or fiber optic systems. Cell phone 16P is linked to the server through wireless cell tower 16T. A modem on mobile laptop 16M is linked on-line to the servers web site through internet 16N. Office computer 16C has on-line access across traditional telephone wires 16W. Availability status database 14S is maintained by the server for storing the availability of each space. Party historical database 14H is also maintained by the server for storing the parking history of certain parkers. The historical record may be for a particular individual driver, and/or a particular vehicle (or fleet of vehicles) and/or the person (or entity) that owns the vehicle. The availability data and historical data in these databases is available to the server during the reservation process.

Parking Space Attributes

Attribute database contains attribute data for each parking space. The data concerns fixed attributes such as physical conditions and variable attributes such as charge rates. These attributes may vary widely depending on the size and complexity or the parking area. The charge rate for each space may depend on these attributes. The requested attributes may address specified conditions within the parking area of the reserved parking space, such as sun or shade, rain or shelter, heat or air conditioning.

One primary attribute may be the dimensions of the space to be reserved. The vehicle (or item being parked) may come in a wide range of sizes, such as a car (big, medium, or compact), a truck (large or small), various mobile units (an ambulance or news broadcasting van), a trailer, or even a shipping container. Large space 12L is suitable for larger vehicles such as panel trucks and SUVs. Compact spaces 12C accept sports cars and other smaller cars. Standard spaces 12S accept regular family sedans and of course all smaller cars. Another of the requested attributes may address loading and unloading capability of the reserved parking space. Space 12Z includes a permanently vacant loading zone for loading and unloading large cargos such as inventory, office furniture, and wheel chairs.

Another major attribute of the requested attributes may be the location within the parking area of the reserved parking space in relationship to exits and other spaces. Space 12E is conveniently nearest the elevators. End space 12F offers one open side free from door “dings”. The owner of a new or upscale car may specify this space at a higher charge rate. The requested attributes may specify a plurality of adjacent parking spaces or at least close together to accommodate an incoming caravan of vehicles. The default value for the number of spaces is one. Parking monitors 18 installed proximate the spaces accept payment for the space rental, and meter the time.

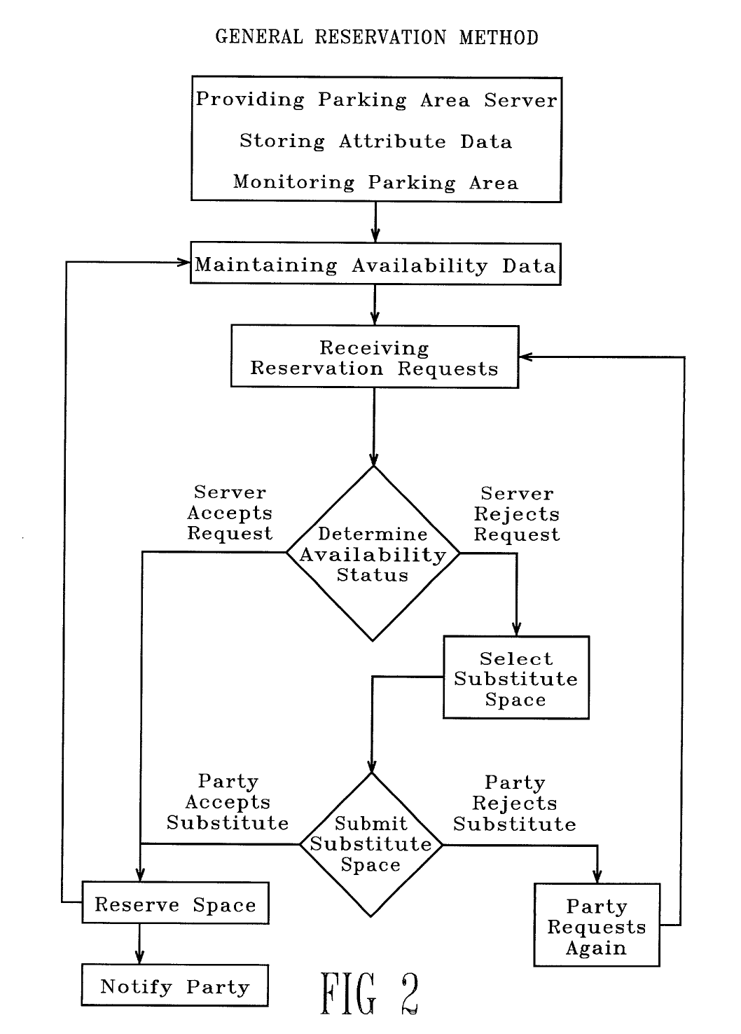

### GENERAL RESERVATION METHOD (FIG. 2)

The steps a general method of reserving parking spaces within a parking area for vehicles through an electronic communication network in response to reservation requests from requesting parties, is shown in the flow chart of FIG. 2, and summarized below. Apparatus for carrying out the above method of operation is disclosed in connection with the detailed description of FIG. 1

Providing a parking area server 14 which is accessible for two-way communication with the requesting parties through electronic communication network 16. The server may be installed in a dust-free, temperature controlled remote computer room or in an on-site utility room. A wireless embodiment may be mounted on a wheeled cart for ready relocation around the parking area.

Storing parking space data in a space attribute database. Space attribute database 14A is in data communication with server 14 for providing parking space data to the server. The space data identifies each parking space in the parking area by a unique space ID, and defines one or more parking space attributes for each parking space.

Monitoring the parking area through parking space monitors positioned in the parking area proximate the parking spaces. Monitors 18 detect the presence or absence of vehicles in the parking spaces defining a current empty/occupied status for each parking space. The monitors are accessible for server communication for providing the empty/occupied status to the server. The parking area monitors may be any suitable vehicle detection system such as optical recognition, motion sensing, and proximity detection. Each parking space may have a dedicated monitor as shown in FIG. 1, or a single monitor may monitor multiple spaces.

Maintaining time-based parking space availability data in availability status database 14S in response to reservations from the server and to empty/occupied status from the monitors. The time-based data defines an availability schedule for each parking space in the parking area. Availability database 14S is maintained by the server on an ongoing basis as parking spaces are reserved and then occupied and eventually vacated. Availability database 14S is in data communication with the server for receiving the availability data from the server, and for providing availability data to the server as required.

Receiving a reservation request communication from a requesting party to the server via electronic communication network 16 requesting a reservation for a parking space in the parking area. The request may originate from home, office, moving vehicle, car rental lobby, an airplane in flight, or any other environment that has access to the communication network. The requesting party may be the driver of the vehicle, a dispatcher, an executive assistance, or even a computer employing a reservation program. The vehicle may be owned and/or driven by the requesting party, or by a third party such as an employee or family member. A single complex server may handle several parking areas in the same locality or multiple parking areas in distant cities through an 800 number. The request may be initiated by clicking on a monitor display menu, entering touch tones in response to a voice menu, or even by checking boxes in a fax request form. The communication from the requesting party may be in the form of an inquiry concerning a particular space and a particular time. Reservation communications may be received by the server on a continuous basis (24 hours a day, seven days a week), or just during specified hours of operation.

One of the requested attributes may be a starting time for the requested reservation. Starting time is a primary attribute defining an open ended time reservation. This open reservation may start before the arrival of the vehicle, and may terminate when the vehicle vacates the space, or may extend in perpetuity. Two related requested attributes are starting time and terminating time defining a reserved closed time slot. Closed time slots may be for a fixed duration, for example for two hours, 24 hours, or a week, and may terminate at the expiration of the time or when the vehicle vacants. Along with time specifications, the request may specify certain other attributes (see above Parking Space Attributes).

Determining availability status of parking spaces having the requested attributes from the availability data in the availability status database, and the parking space data in the space attribute database. The server determines if a space is available having the specified attributes during the specified time slot.

Relecting the reservation request from the requesting party if no parking space having the requested attributes is available.

Accepting the reservation request from the requesting party if a parking space having the requested attributes is available.

Reserving the parking space having the requested attributes for the requesting party using the unique space ID.

Notifying the requesting party of the reservation.

Updating the availability status database as to the now unavailability of the just reserved parking space.

The accessible server communication may be continuous one-way communication from the monitors to the server for reporting the empty/occupied status. Alternatively, the accessible server communication may be continuous two-way communication between the monitor to the server. The server may periodically interrogate the monitors, and may forward reservation and charge information to be displayed on the monitors. The physical medium of the server/monitor communication (indicated in FIG. 1 by dashed lines) may be wireless transmissions or wired signals (cable, optics etc.). Wireless embodiment may be enhanced by transmit/receive antennas extending from the server across the ceiling of the parking area to the proximity the monitors. Such enhanced systems require less power to transmit and receive, and get reduced ambient electrical noise and interference from other wireless transmissions. The antenna may be a matrix or “tree” with a lead to each monitor.

Substitute Alternate Parking Spaces

If a suitable space is available, the server accepts the request, reserves the space, and notifies the requesting party. If such a space is not available, the server rejects the request, consults availability status database 14S, and executes the additional steps of:

Selecting an substitute alternate space from the available parking spaces based on the availability data; and

Submitting the substitute alternate space to the requesting party for acceptance as a substitute space. That is, the alternate parking space is a substitute space having substitute attributes approximating the original requested attributes. The substitute space is submitted to the requesting party for either acceptance or rejection. If the party accepts the substitute space, the server reserves the space. If the party rejects the space, the party may specify other time slots and/or attributes. That is, after the alternate submitting step and before the determining step, the reservation method may include the additional step of

receiving an alternate reservation request during the reservation request communication specifying substitute attributes.

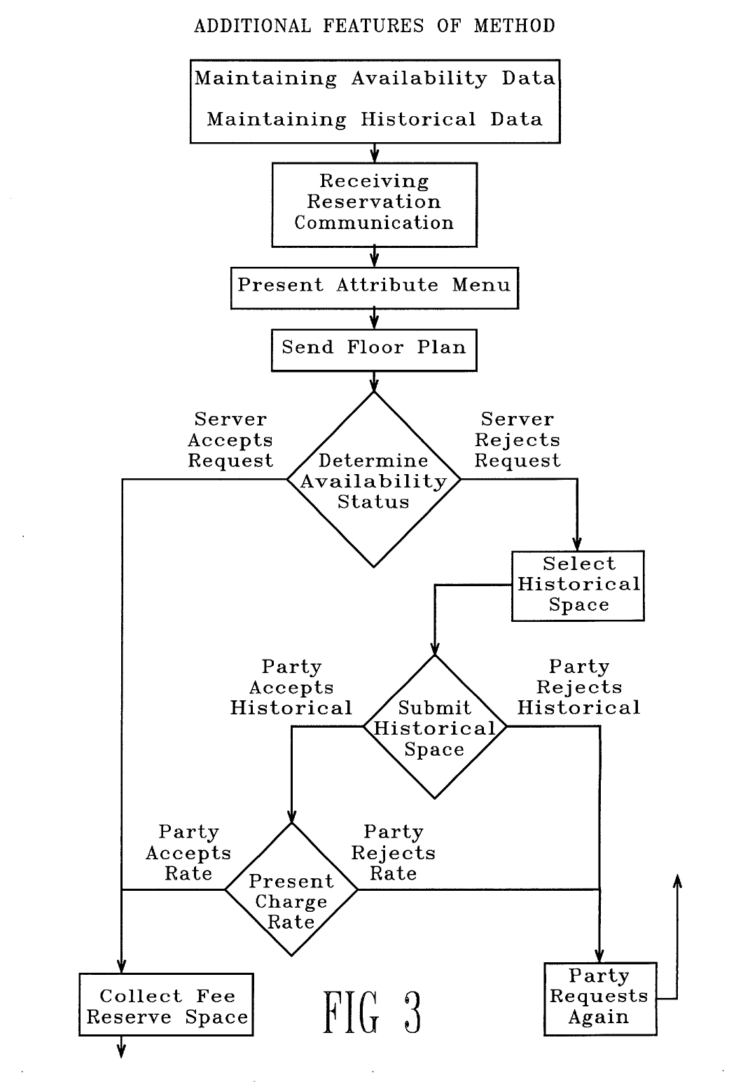

### ADDITIONAL FEATURES OF METHOD (FIG. 3)

Additional features of the reservation method of FIG. 2 are shown in FIG. 3.

Maintaining a requesting Party historical database in data communication with the server for certain requesting parties identified by a unique party ID defining one or more historically requested attributes. The alternate parking space selected by the server may be a historical space having attributes based on historically requested attributes. Party historical database 14H may be maintained by the server on an ongoing basis as parking spaces are reserved and then occupied and eventually vacated.

After the reserving step, the server may execute the additional step of

updating the party historical database with the attributes requested by the requesting party. The historical database may contain a record of the parking history of frequent parkers, and/or recent parkers, and/or a select group of parkers (or every parker).

After the requests are received, the server may present an attribute menu to the requesting party listing the attribute available for the requested time slot. The menu may have a default selection for requesting parties who do not require any particular attributes. The default selection may be a standard minimal space, or an upgraded space if a minimal space is unavailable.

Floor Plan

After the receiving step and before the reserving step, the server may execute the additional step of

sending an image of the floor plan of the parking area to the requesting party indicating the locations of available parking spaces. The floor plan image may be displayed on a full scale desktop monitor, or on a smaller laptop computer, or even a palm pilot device. In a facsimile mode embodiment, a hard copy of the floor plan may be faxed to the requesting party. A visible “availability” que may be displayed such as a flashing light or color inversion. The floor plan may be in the form of a level stack, permitting the requesting party to click through the stack to view the floor plan level by level. The floor plan may indicate availability based on viewer attribute sets, such as simple availability, available now or available at a specified future time slot, or availability in combination with certain physical attributes (such as unloading capability).

After receiving the reservation request, the server determines availability and either accepts or rejects the request as per FIG. 2. In the case of a rejection, the server consults historical database 14H and selects an historically based space as an historical alternative to the requested space. The requesting party either accepts or rejects the historical alternative.

Charge Rates

One of the parking space attributes may be a charge rate attribute paid by the requesting party. The charge rate may vary depending on the type or space requested, the time of day (higher charge for peak times), and the day of the week (surcharge for busy Saturday nights). Daily commuters and frequent parkers with an account may receive a discount. The charge may be by the hour, or a flat monthly fee for unlimited parking. After the determining step and before the reserving step, the server may execute the additional step of

presenting the charge rate attribute to the requesting party for the space having the requested attributes. The charge rate for the accepted space may be presented after the acceptance of the initial request by the server (or acceptance of the alternative space by the party). If the party accepts the charges, the server collects the fee and reserves the space and notifies the requesting party confirming that the space has been reserved and that payment has been received.

After the accepting step, the server may execute the additional step of

electronically collecting a fee based on the charge rate for the accepted parking space.

Holdovers and Intruders

Some parkers may “holdover”, that is stay in the parking space beyond reserved time slot. Other parkers may “intrude”, that is take a parking space without a reservation or making provision for payment. Both holdovers and intruders interrupt the time-based availability schedules, and may be subject to a higher charge rate. After the reserving step, the server may execute the additional steps of clocking the reserved time slot; and alerting the requesting party when the time slot is approaching expiration or has expired. The alerting may include a telephone call (or e-mail) to the parker informing the parker of the holdover status and possible rate increase.

### INDUSTRIAL APPLICABILITY

It will be apparent to those skilled in the art that the objects of this invention have been achieved as described hereinbefore by providing a method of electronically reserving a parking space. Attributes of available spaces are provided for better informing the requesting parties of their reservations options. The requesting party to reserve a parking space from a remote location in advance of an event. In a single transaction, the requesting party may make a sequence of reservations. The requesting party to reserve a parking space “on-the-fly” with short notice from his vehicle while driving to the parking area. The request may be accepted or rejected almost instantaneously during the request inquiry. The server may submit a close substitute alternate parking space based on the requested attributes when the requested space is not available. In addition, the server may submit a historical alternate parking space based on prior requests when the requested space is not available.

Clearly various changes may be made in the structure and embodiments shown herein without departing from the concept of the invention. Further, features of the embodiments shown in the various figures may be employed with the embodiments shown in the other figures.

Therefore, the scope of the invention is to be determined by the terminology of the following claims and the legal equivalents thereof.

We claim as our invention:

1) Method of reserving parking spaces within a parking area for vehicles through an electronic communication network in response to reservation requests from requesting parties, comprising the steps of:
providing a parking area server which is accessible for two-way communication with the requesting parties through the electronic communication network;
storing parking space data in a space attribute database, identifying each parking space in the parking area by a unique space ID,defining one or more parking space attributes for each parking space, and in data communication with the server for providing parking space data to the server;
monitoring the parking area through parking space monitors positioned in the parking area proximate the parking spaces, for detecting the presence or absence of vehicles in the parking spaces defining a current empty/occupied status for each parking space, and accessible for server communication for providing the empty/occupied status to the server;
maintaining time-based parking space availability data in an availability status database in response to reservations from the server and to empty/occupied status from the monitors, defining an availability attribute schedule for each parking space in the parking area, and in data communication with the server for providing availability data to the server;
receiving a reservation request communication from a requesting party to the server via the electronic communication network, requesting a reservation for a parking space in the parking area specifying one or more requested attributes;
determining the availability of parking spaces having the requested attributes from the availability data in the availability status database and from the parking space data in the space attribute database;
rejecting the reservation request from the requesting party if no parking space having the requested attributes is available;
accepting the reservation request from the requesting party if a parking space having the requested attributes is available; and
reserving the parking space having the requested attributes for the requesting party using the unique space ID.

2) The method of claim 1, wherein one of the requested attributes is starting time of the requested reservation.

3) The method of claim 1, wherein two of the requested attributes are starting time and terminating time of the requested reservation defining a reserved time slot.

4) The method of claim 3, further comprising after the reserving step, the additional steps of:
clocking the reserved time slot; and
alerting the requesting party when the time slot is approaching expiration or has expired.

5) The method of claim 1, wherein the requested attributes include specified conditions within the parking area of the reserved parking space.

6) The method of claim 1, wherein one of the requested attributes is location within the parking area of the reserved parking space.

7) The method of claim 1, wherein one of the requested attributes is loading and unloading capability of the reserved parking space.

8) The method of claim 1, wherein one of the requested attributes is dimensions of the reserved parking space.

9) The method of claim 1, wherein one of the requested attributes specifies a plurality of the parking spaces.

10) The method of claim 1, wherein one of the parking space attributes is a charge rate attribute.

11) The method of claim 10, further comprising after the determining step and before the reserving step, the additional step of presenting to the requesting party the charge rate attribute for the space having the requested attributes.

12) The method of claim 11, further comprising after the accepting step, the additional step of electronically collecting a fee based on the charge rate for the accepted parking space.

13) The method of claim 1, further comprising after the reserving step, the additional step of notifying the requesting party of the reserved parking space.

14) The method of claim 1, further comprising after the reserving step, the additional step of updating the availability status database as to the now unavailability of the just reserved parking space.

15) The method of claim 1, wherein the accessible server communication is continuous one-way communication from the monitors to the server.

16) The method of claim 1, wherein the accessible server communication is continuous two-way communication between the monitor to the server.

17) The method of claim 1, further comprising after the receiving step and before the reserving step, the additional step of sending an image of the floor plan of the parking area to the requesting party indicating the available parking spaces.

18) The method of claim 1, further comprising after the rejecting step, the additional steps of:
selecting an alternate available parking space; and
submitting the alternate available parking space to the requesting party.

19) The method of claim 18, wherein the alternate parking space is a substitute space having substitute attributes based on the requested attributes.

20) The method of claim 18, further comprising the additional step of maintaining a requesting party historical database in data communication with the server for certain requesting parties identified by a unique party ID defining one or more historically requested attributes.

21) The method of claim 20, wherein the alternate parking space is a historical space having attributes based on historically requested attributes.

22) The method of claim 20, further comprising after the reserving step, the additional step of updating the historical database with the attributes requested by the requesting party.

23) The method of claim 18, further comprising after the alternate submitting step and before the determining step, the additional step of receiving an alternate reservation request during the reservation request communication specifying alternate attributes.
